(19) United States
(12) Patent Application Publication
(10) Pub. No.: US 2015/0081346 A1
(43) Pub. Date: Mar. 19, 2015

(54) EVENT TICKET SHARING VIA NETWORKED MOBILE COMPUTING DEVICES

(71) Applicant: Jade Makani Roberge Charles, San Diego, CA (US)

(72) Inventor: Jade Makani Roberge Charles, San Diego, CA (US)

(73) Assignee: FRAGMOB, LLC, San Diego, CA (US)

(21) Appl. No.: 14/031,698

(22) Filed: Sep. 19, 2013

(51) Int. Cl. G06Q 10/02

(52) U.S. Cl. CPC G06Q 10/02
USPC 705/5

(57) ABSTRACT

A method on a web server for facilitating sharing of tickets over a communications network is disclosed. The method includes storing ticket records for tickets purchased by a user for an event venue, generating electronic tickets corresponding to the ticket records, wherein each electronic ticket is configured for redemption at an event venue. The method further includes transmitting the electronic tickets to the user, and receiving a unique identifier for a friend of the user. The method further includes accessing a ticket record corresponding to one of the electronic tickets and replacing the unique identifier for the user with the unique identifier for the friend. The method further includes transmitting the electronic ticket corresponding to the ticket record to the mobile computing device of the friend via the communications network.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The disclosed embodiments relate to the field of electronic commerce and, more specifically, the disclosed embodiments relate to the field of online ticketing for event venues using mobile computing devices.

### BACKGROUND OF THE INVENTION

In recent years, the use of electronic tickets has gained wide acceptance among users. An electronic ticket is a digital ticket that can be displayed on the screen of a mobile device and used to enter into an event venue. Upon reaching the entrance of an event venue, a user typically presents the screen of his mobile device, which displays the electronic ticket, for scanning. Subsequently, a worker at the entrance of the venue uses a scanner or similar device to scan the screen of the mobile device, which reads the information in the electronic ticket. Consequently, a computer program verifies the validity of the electronic ticket and the user is allowed to enter into the event venue.

One of the drawbacks associated with conventional electronic tickets for event venues involves the inability to share the electronic tickets with friends. Conventionally, a user that purchases a group of electronic tickets for use by a group of people is provided with one or more electronic tickets that are displayed in a mobile application, or a similar program, on his mobile computing device. At the point of entrance into the event venue, the user that purchased the group of tickets must present the electronic tickets for entrance of the entire group of people at the same time. Problems can arise, however, when the entire group of people cannot be present at the entrance of the event venue at the same time. This situation requires that the user with the electronic tickets on his mobile device return to the entrance at a later time when the remaining people in his party have arrived. This can be time consuming and annoying for groups of attendees that cannot be present at the entrance to the event venue simultaneously.

Another drawback associated with conventional electronic tickets involves confirming that the ticket has been used. Dishonest attendees to an event may attempt to copy electronic tickets or use them more than once to gain entrance to the event venue without paying. Thus, upon entrance into the event venue, all electronic tickets must be checked and quickly validated to ensure that an electronic ticket is valid and has not previously been used. This can be a complex problem to solve, when events involving thousands of electronic tickets are involved.

Therefore, what is needed is a system and method for improving the problems with the prior art, and more particularly for a more efficient method and system for facilitating the sharing of electronic tickets for event venues among attendees.

### BRIEF SUMMARY OF THE INVENTION

In one embodiment, a method on a web server for facilitating sharing of tickets over a communications network is disclosed. The method includes storing in an attached database a plurality of ticket records for tickets purchased by a user for an event venue, wherein each ticket record includes a unique ticket identifier, and a unique identifier for the user, and generating a plurality of electronic tickets corresponding to the plurality of ticket records, wherein each electronic ticket is configured for redemption at an event venue. The method further includes transmitting the plurality of electronic tickets to the mobile computing device of the user via the communications network, and receiving, via the communications network, a unique identifier for a friend of the user, wherein the unique identifier for the friend is entered by the user into a graphical user interface. The method further includes accessing a particular one of the plurality of ticket records in the attached database and replacing the unique identifier for the user with the unique identifier for the friend, and transmitting the electronic ticket corresponding to the particular one of the plurality of ticket records to the mobile computing device of the friend via the communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a block diagram illustrating the network architecture of a system for facilitating sharing of electronic tickets over a communications network, in accordance with one embodiment.

FIG. 2A is a block diagram showing the data flow pertaining to a user of the system for sharing of electronic tickets over a communications network according to one embodiment.

FIG. 2B is a block diagram showing the data flow pertaining to a friend of the user with regard to the system for sharing of electronic tickets over a communications network, according to one embodiment.

FIG. 3A is a flow chart depicting the general control flow of a process for facilitating sharing of electronic tickets over a communications network, according to one embodiment.

FIG. 3B is a diagram depicting the data flow and control flow between the main players of the process for facilitating sharing of electronic tickets over a communications network, according to one embodiment.

FIG. 4 is a block diagram of a system including an example computing device and other computing devices.

### DETAILED DESCRIPTION OF THE INVENTION

The disclosed embodiments improve upon the problems with the prior art by providing a system that allows a user that has purchased multiple electronic tickets for use by a group of persons to share one or more of those tickets with a second person. Once an electronic ticket is shared with the second person, he or she may use the electronic ticket on its own, without requiring the presence of the purchasing user. Therefore, the disclosed embodiments reduce or eliminate the need for the purchasing user to be present at the entrance of an event venue in order for all members of the group to gain access to the event venue. This is advantageous for the attendees, as it provides greater flexibility in the use of the electronic tickets and allows the attendees of a group to arrive at the event venue at difference times, while still allowing them independent access to the event venue. An additional benefit of the disclosed embodiments is the automatic confirmation of use of an electronic ticket and the subsequent invalidation of the electronic ticket, which eliminates the ability of dishonest attendees from copying an electronic ticket or attempting to use it more than once.

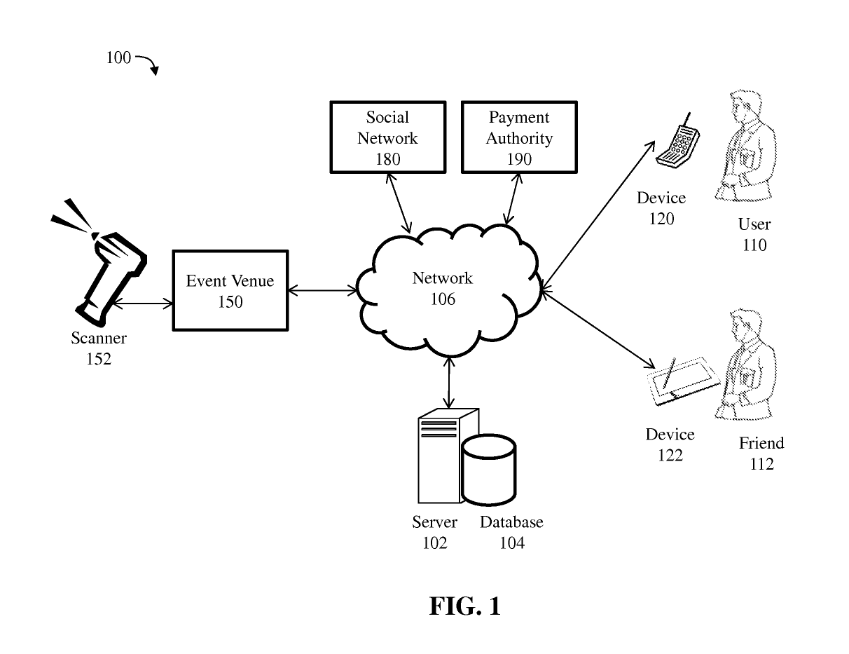

Referring now to the drawing figures in which like reference designators refer to like elements, there is shown in FIG. 1 an illustration of a block diagram showing the network architecture of a system 100 and method for facilitating sharing of electronic tickets over a communications network in accordance with one embodiment. A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, the sharing of electronic tickets between users.

FIG. 1 includes mobile computing devices 120 and 122, which may be smart phones, mobile phones, tablet computers, handheld computers, laptops, or the like. Mobile computing devices 120 and 122 correspond to a user 110 and a friend 112 of the user 110. FIG. 1 further shows that server 102 includes a database or repository 104, which may be a relational database comprising a Structured Query Language (SQL) database stored in a SQL server. Devices 120, 122 and 150 may also each include their own database. The repository 104 serves data from a database, which is a repository for data used by server 102 and devices 120, 122, 150 during the course of operation of the disclosed embodiments. Database 104 may be distributed over one or more nodes or locations that are connected via network 106.

The database 104 may include a user record for each user 110 or 112. A user record may include: contact/identifying information for the user (name, address, telephone number(s), email address, etc.), an IP address for a mobile computing device of the user, information pertaining to electronic tickets associated with the user, contact/identifying information for friends of the user, electronic payment information for the user, information pertaining to the purchases made by the user, sales transaction data associated with the user, etc. A user record may also include a unique identifier for each user, a residential address for each user, the current location of each user (based on location-based services from the user's mobile computer) and a description of past electronic tickets purchased by each user. A user record may further include demographic data for each user, such as age, sex, income data, race, color, marital status, etc.

Sales transaction data may include one or more product/service identifiers (such as SKUs), one or more product/service amounts, buyer contact/identifying information, event information, event venue information and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a ticket record for each electronic ticket. A ticket record may include: a unique ticket identifier, contact/identifying information for the user or users (unique identifier for the user, name, address, telephone number(s), email address, etc.) associated with the electronic ticket, an IP address for a mobile computing device of the user associated with the ticket, information pertaining to the number of users associated with the electronic ticket, event information, event venue information, seat data, row data, section data, date and time data, additional services data (such as concierge, VIP service or valet parking services) and a data element that indicates whether an electronic ticket has been used or redeemed. In another embodiment, a ticket record may include a unique code for each ticket, such any one of a unique alphanumeric value, a matrix barcode, a linear barcode or a unique image. An electronic ticket is defined as a representation of the corresponding ticket record, on a mobile computing device of a user. In one embodiment, an electronic ticket is a file or other data structure residing on the mobile device of a user, wherein, when opened or activated, displays the unique code, and/or any of the data, of a ticket record.

FIG. 1 shows an embodiment of the present invention wherein networked computing devices 120, 122 interact with server 102 and repository 104 (as well as entities 150, 180 and 190) over the network 106. Server 102 includes a software engine that delivers applications, data, program code and other information to networked computing devices 120, 122 (as well as entities 150, 180 and 190). It should be noted that although FIG. 1 shows only the networked computers 102, 120, 122, 150, 180 and 190, the system of the disclosed embodiments supports any number of networked computing devices connected via network 106. Further, server 102, entities 150, 180 and 190, and devices 120, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 120, 122, event venue 150, payment authority 190 or social network 180. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by users 110 or 112 for electronic tickets, or the like. In the course of a sales transaction, server 102 may interface with payment authority 190 to effectuate payment. In one embodiment of the present invention, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc. FIG. 1 further shows social network 180, which may be a third party social network that provides a web based social networking service. A social networking service consists of a representation of each user (often a profile), his/her social links, and a variety of additional services, such as a means for users to interact over the Internet, including e-mail and instant messaging. A social networking service may further allow users to share ideas, pictures, posts, activities, events, and interests with others.

FIG. 1 also shows event venue 150, which represents a location for an event, such as a music venue, a sport venue, a theater, an arena, a stage, an amphitheater, an outdoor concert structure, stadium, bandshell, bandstand, concert hall, opera house, nightclub, discotheque, park, restaurant, bar, pub, sports complex, etc. The event venue 150 may also represent the information technology infrastructure, including servers and computers, which are used by the event venue 150 to manage electronic tickets and the entrance of attendees into the venue. Scanner 152 is shown as part of the event venue 152. Workers at an event venue are often seen holding handheld scanners that are used to scan electronic tickets upon entrance. Scanner 152 may be an infrared scanner, a bar code scanner, an image scanner, barcode reader, biometric scanner, RFID scanner, NFC scanner, etc.

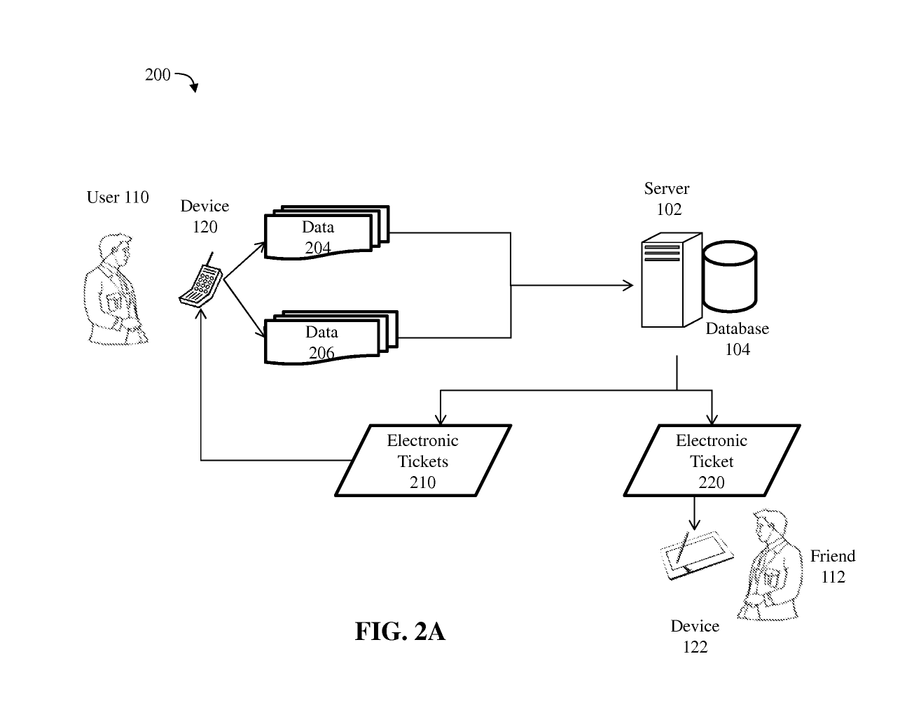

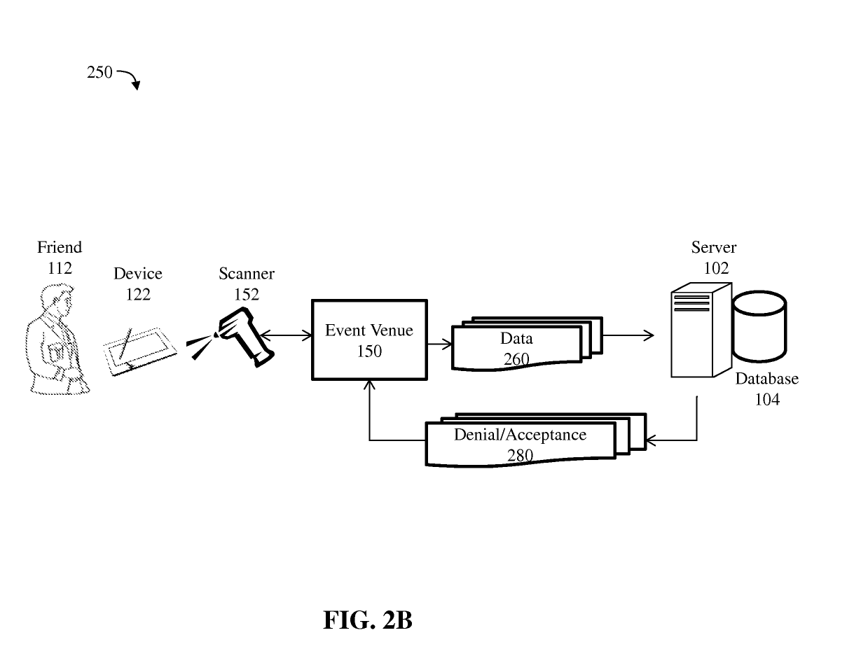

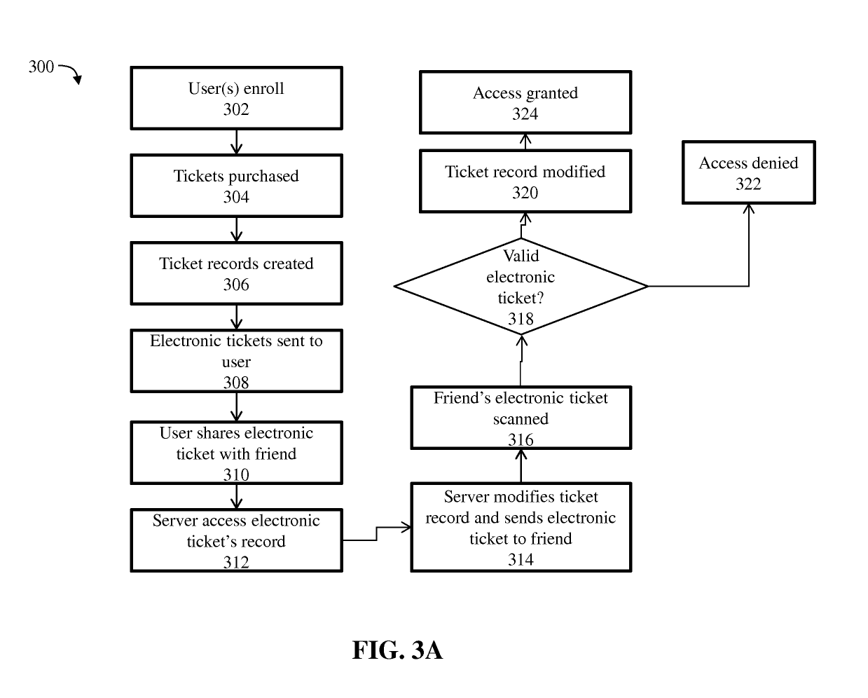

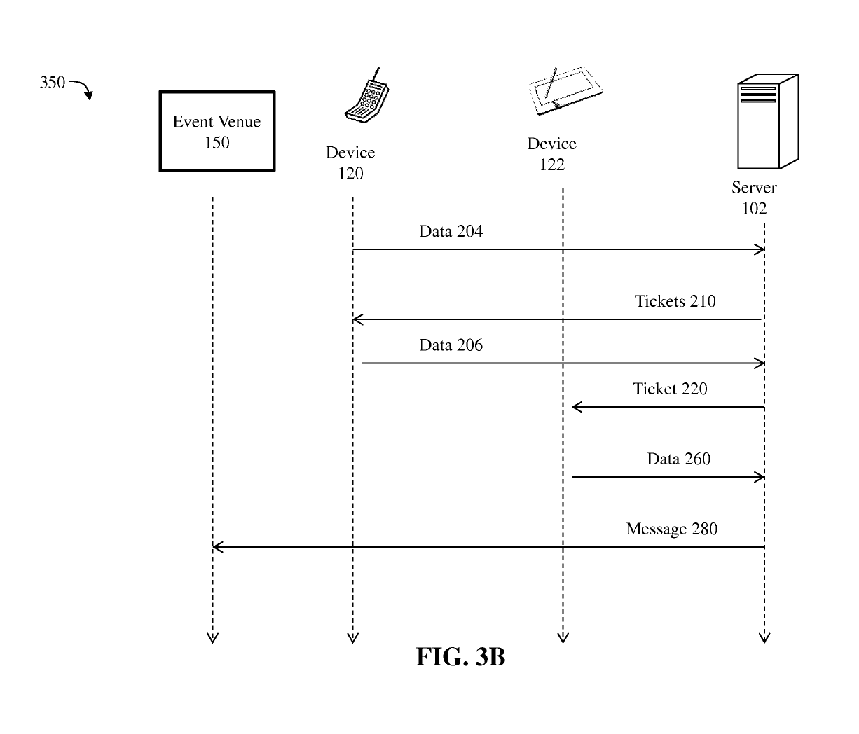

The process of sharing electronic tickets will now be described with reference to FIGS. 2A through 3B below. FIGS. 2A through 3B depict the data flow and control flow in the process for facilitating sharing of electronic tickets over a communications network 106, according to one embodiment. The process of the disclosed embodiments begins with optional step 302 (see flowchart 300), wherein the users 110 and/or 112 may enroll or register with server 102, social network 180 and/or event venue 150. In the course of enrolling or registering, user 110 may enter data into his device 120 by manually entering data into a mobile application via keypad, touchpad, or via voice. In the course of enrolling or registering, the user 110 may enter any data that may be stored in a user record, as defined above. Also in the course of enrolling or registering, the server 102, social network 180 and/or event venue 150 may generate a user record for each registering user and store the user record in an attached database, such as database 104.

Subsequently, in step 304, the user 110 purchases tickets to attend an event at an event venue. The user 110 may purchase the tickets utilizing his mobile computing device 120. In the course of purchasing the tickets, user 110 may enter electronic payment information (i.e., data 204) into his device 120 by manually entering data into a mobile application via keypad, touchpad, or via voice (see diagram 200). User 110 may alternatively enter data 204 into his device 120 by using Radio Frequency Identification (RFID), or Near Field Communication (NFC). RFID is the use of a wireless non-contact system that uses radio-frequency electromagnetic fields to transfer data from one node to another. NFC is a set of standards for smart-phones and similar devices to establish radio communication by bringing nodes into close proximity.

Alternatively, user 110 may also enter data 204, or a portion thereof, into his device 120 by swiping a purchase card through a card reader communicatively coupled with the device 120. A card reader is a data input device that reads data from a card-shaped storage medium. One example of a card reader is a magnetic card reader, which reads magnetic stripe cards, such as credit cards. A mobile card reader is a card reader that is communicatively coupled with a mobile computing device. In one embodiment, upon reading any purchase card data, the device 120 immediately encrypts the purchase card data that was read, so as to produce encrypted purchase card data. In this embodiment, the encrypted purchase card data is transmitted to the server 102 in data 204.

Also in step 304, the data 204, or a portion thereof, may be transmitted to payment authority 190 for processing. The payment authority 190 processes the electronic payment information of the user 110 and verifies whether payment has been effectuated. If so, the payment authority 190 may send a verification message to the server 102 thereby verifying that the payment has been effectuated. The data 204 may be stored in association with the user record for user 110.

In the next step 306, the server 102 may generate and store in database 104 one or more ticket records for the tickets purchased by the user 110. Also in step 306, the server 102 may generate a unique code for each ticket, such any one of a unique alphanumeric value, a matrix barcode, a linear barcode or a unique image. The unique code for each ticket may be stored in the corresponding ticket record for that ticket. In one alternative, step 306 is only executed if the payment authority 190 sends a verification message to the server 102 verifying that payment has been effectuated in step 304. Next, in step 308, server 102 generates one or more electronic tickets 210, corresponding to the tickets purchased by the user 110 in step 304 and corresponding to the ticket records created in step 306, and transmits the electronic tickets 210 to the mobile device 120 of the user 110. Also in step 308, the server 102 may optionally transmit the electronic tickets 210 (and/or the corresponding ticket records, or a portion thereof) to the event venue 150.

In one embodiment, in step 308, the server 102 may transmit the electronic tickets 210 to the mobile device 120 of the user 110: 1) via a network protocol, such as HTTP, to the IP address of the mobile device 120 of the user 110, as the IP address is stored in the ticket record(s) associated with the electronic tickets 210 or the user record of the user 110, or in response to an HTTP request from the mobile device 120 of the user 110 (wherein the HTTP request includes the IP address of the device 120), or 2) via text message to the telephone number of the mobile device 120 of the user 110, as the telephone number is stored in the ticket record(s) associated with the electronic tickets 210 or the user record of the user 110, or in response to a text message from the mobile device 120 of the user 110 (wherein the text message includes the telephone number of the device 120).

Next, in step 310, the user 110 decides to share one or more of the electronic tickets 210 with his friend 112. In step 310, the user 110 may enter data 206 identifying his friend 112 (such as a unique name, a unique identifier, a telephone number, email address, social network sign-in, contact information, etc.) into his device 120 by manually entering data into a mobile application via keypad, touchpad, or via voice. In step 310, the user 110 also identifies in data 206 (such as via a unique ticket identifier, etc.) which of the electronic tickets he would like to transfer to his friend 112. In step 312, the server 102 receives data 206 and accesses the ticket record in the database 104 corresponding to the electronic ticket identified by the data 206 (such as the unique ticket identifier). In step 314, the server 102 modifies the data in the ticket record that was accessed to reflect that ownership of the ticket has been changed to the friend 112. In one embodiment, the server 102 opens the ticket record and replaces the unique identifier for the user 110 (and/or the telephone number/email address/IP address for the mobile computing device of the user 110) with the unique identifier for the friend 112 (and/or the telephone number/email address/IP address for the mobile computing device of the friend 112). Also in step 314, the server 102 transmits, to the device 122 of the friend 112, the electronic ticket 220 corresponding to the ticket record that was modified.

In one embodiment, in step 314, the server 102 may transmit the electronic ticket 220 to the mobile device 122 of the friend 112: 1) via a network protocol, such as HTTP, to the IP address of the mobile device 122 of the friend 112, as the IP address is stored in the ticket record(s) associated with the electronic ticket 220 or the user record of the friend 112, or in response to an HTTP request from the mobile device 122 of the friend 112 (wherein the HTTP request includes the IP address of the device 122), or 2) via text message to the telephone number of the mobile device 122 of the friend 112, as the telephone number is stored in the ticket record(s) associated with the electronic ticket 220 or the user record of the friend 112, or in response to a text message from the mobile device 122 of the friend 112 (wherein the text message includes the telephone number of the device 122).

In step 316, the friend 112 attends the event and presents the electronic ticket 220 (displayed on his device 122, for example) for scanning by a scanner 152 at the event venue 150. In this step, the scanner 152 may read data 260 from the electronic ticket 210, which is transmitted from the event venue 150 to the server 102 (see diagram 250). The data 260 may be any data included in the electronic ticket, such as a unique ticket identifier.

In step 318, the server 102 receives data 260 and accesses the ticket record in the database 104 corresponding to the electronic ticket 220 identified by the data 260 (such as the unique ticket identifier). The server 102 then determines whether the electronic record 220 is still valid, i.e., has not been used yet. Specifically, the server 102 opens the ticket record and checks the data element that indicates whether an electronic ticket has been used or redeemed. If the data element indicates that the electronic ticket 220 has not been used or redeemed, then the control flows to step 320. If the data element indicates that the electronic ticket 220 has been used or redeemed, then the control flows to step 322 wherein a denial message 280 is transmitted to the event venue 150 and/or scanner 152 and the friend 112 is denied entrance into the event venue 150.

In step 320, the server 102 then modifies the data in the ticket record that was accessed to reflect that the ticket has been used by the friend 112 to gain entrance into the event venue 150, and is therefore no longer valid. In one embodiment, the server 102 opens the ticket record and modifies the data element that indicates whether an electronic ticket has been used or redeemed with a data element that confirms that the electronic ticket has been used or redeemed. Subsequently, control flows to step 324 wherein an acceptance message 280 is transmitted to the event venue 150 and/or scanner 152 and the friend 112 is allowed entrance into the event venue 150.

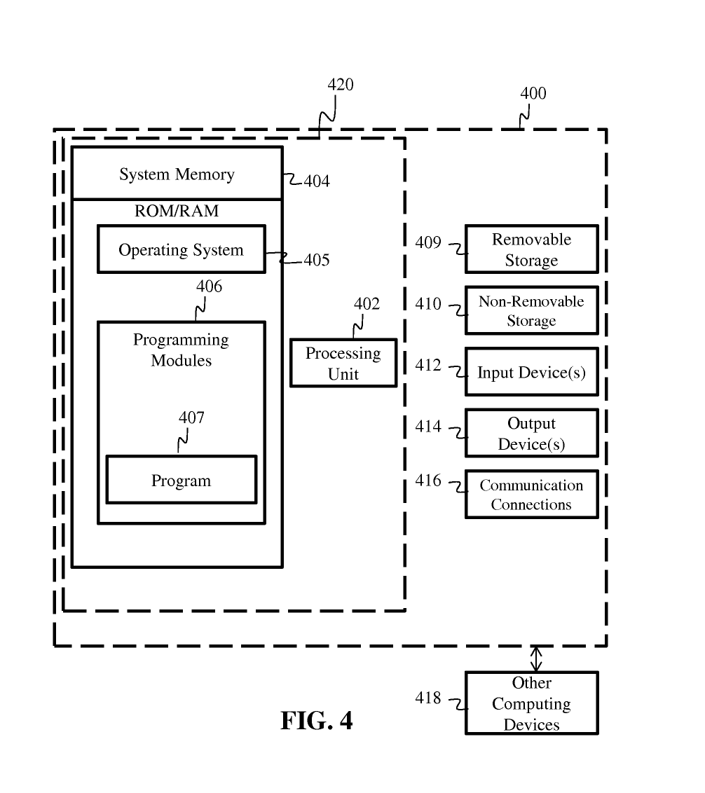

FIG. 4 is a block diagram of a system including an example computing device 400 and other computing devices. Consistent with the embodiments described herein, the aforementioned actions performed by 102, 120, 122, and 150 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2A-3B above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2A-3B above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A web server for facilitating sharing of tickets over a communications network, comprising:
a database for storing in an attached database a plurality of ticket records, wherein each ticket record includes a unique ticket identifier, and a unique identifier for a user;
a network interface device communicatively coupled with the communications network; and
a processor configured for:
storing in the database a plurality of ticket records for tickets purchased by a user for entrance by the user to a particular event at an event venue;
generating a plurality of electronic tickets corresponding to the plurality of ticket records, wherein each electronic ticket is configured for entrance by the user to the particular event at the event venue, and wherein each electronic ticket comprises a unique ticket identifier from a corresponding ticket record;
transmitting the plurality of electronic tickets to the mobile computing device of the user via the communications network;
receiving, via the communications network, a unique identifier for a friend of the user, wherein the unique identifier for the friend is entered by the user into a graphical user interface on the mobile computing device of the user;
accessing in the attached database a particular one of the plurality of ticket records corresponding to a first electronic ticket of the plurality of electronic tickets and replacing the unique identifier for the user with the unique identifier for the friend; and
transmitting the first electronic ticket corresponding to the particular one of the plurality of ticket records to a mobile computing device of the friend via the communications network, wherein the first electronic ticket is configured for entrance by the friend to the particular event at the event venue.

2. The method of claim 1, further comprising:
receiving, via the communications network, a message, including a unique ticket identifier, from the event venue, wherein the unique ticket identifier has been garnered via scanning of the unique ticket identifier of the first electronic ticket at the particular event at the event venue;
accessing a ticket record in the attached database using the unique ticket identifier from the first electronic ticket, wherein the ticket record corresponds to the unique ticket identifier; and
storing a data element in the ticket record indicating that the first electronic ticket has been redeemed.

3. The method of claim 2, wherein the step of storing a plurality of ticket records further comprises:
storing a plurality of ticket records in an attached database, wherein each ticket record includes a data element indicating that the electronic ticket has not been redeemed.

4. The method of claim 3, wherein the step of generating a plurality of electronic tickets further comprises:
generating, for each of the plurality of electronic tickets, a unique code comprising any one of a unique alphanumeric value, a matrix barcode, a linear barcode or a unique image.

5. The method of claim 4, wherein the step of transmitting the plurality of electronic tickets further comprises:
transmitting the plurality of electronic tickets, and the unique code corresponding to each electronic ticket, to the mobile computing device of the user via the communications network.

6. The method of claim 5, wherein the step of transmitting the electronic ticket further comprises:
transmitting the electronic ticket corresponding to the particular one of the plurality of ticket records, and the unique code corresponding to the electronic ticket, to the mobile computing device of the friend via the communications network.

7. The method of claim 6, wherein the step of receiving the message from the event venue further comprises:
receiving the message, further including a time stamp, from the event venue, wherein the time stamp corresponds to a time of scanning of the electronic ticket at the event venue.

8. A web server for facilitating sharing of tickets over a communications network, comprising:
a database for storing in an attached database a plurality of ticket records, wherein each ticket record includes a unique ticket identifier, a unique code, a unique identifier for a user, and a telephone number for a mobile computing device of said user;
a network interface device communicatively coupled with the communications network; and
a processor configured for:
receiving, via the communications network, electronic payment information that has been entered by a user into a graphical user interface on a mobile computing device of the user for purchase of tickets for entrance of the user to a particular event at an event venue;
processing the electronic payment information to effectuate payment for the tickets;
storing in the attached database a plurality of ticket records corresponding to the tickets purchased by the user for entrance of the user to the particular event at the event venue, wherein each ticket record includes a telephone number for the mobile computing device of the user;
generating a plurality of electronic tickets corresponding to the plurality of ticket records, wherein each electronic ticket is configured for entrance by the user to the particular event at the event venue;
transmitting the plurality of electronic tickets, and the corresponding unique codes for each electronic ticket, to the telephone number of the mobile computing device of the user via the communications network;
receiving, via the communications network, a unique identifier for a friend of the user and a telephone number for a mobile computing device of the friend, wherein the unique identifier for the friend and the telephone number are entered by the user into a graphical user interface on the mobile computing device of the user;
accessing in the attached database a particular one of the plurality of ticket records corresponding to a first electronic ticket of the plurality of electronic tickets and replacing the unique identifier for the user and the telephone number for the mobile computing device of the user with the unique identifier for the friend and the telephone number for the mobile computing device of the friend; and
transmitting the first electronic ticket corresponding to the particular one of the plurality of ticket records, and the corresponding unique code for the first electronic ticket, to the telephone number of the mobile computing device of the friend via the communications network, wherein the first electronic ticket is configured for entrance by the friend to the particular event at the event venue.

9. The method of claim 8, further comprising:
receiving, via the communications network, a message, including a unique ticket identifier, from the event venue, wherein the unique ticket identifier has been garnered via scanning of the unique code of the first electronic ticket at the particular event at the event venue;
accessing a ticket record in the attached database using the unique ticket identifier from the first electronic ticket, wherein the ticket record corresponds to the unique ticket identifier; and
storing a data element in the ticket record indicating that the first electronic ticket has been redeemed.

10. The method of claim 9, wherein the step of storing a plurality of ticket records further comprises:
storing a plurality of ticket records in an attached database, wherein each ticket record includes a data element indicating that the electronic ticket has not been redeemed.

11. The method of claim 10, wherein the step of generating a plurality of electronic tickets further comprises:
generating, for each of the plurality of electronic tickets, a unique code comprising any one of a unique alphanumeric value, a matrix barcode, a linear barcode or a unique image.

12. The method of claim 11, wherein the step of transmitting the plurality of electronic tickets further comprises:
transmitting the plurality of electronic tickets, and the unique code corresponding to each electronic ticket, to the telephone number of the mobile computing device of the user via the communications network.

13. The method of claim 12, wherein the step of transmitting the electronic ticket further comprises:
transmitting the electronic ticket corresponding to the particular one of the plurality of ticket records, and the unique code corresponding to the electronic ticket, to the telephone number of the mobile computing device of the friend via the communications network.

14. The method of claim 13, wherein the step of receiving the message from the event venue further comprises:
receiving the message, further including a time stamp, from the event venue, wherein the time stamp corresponds to a time of scanning of the electronic ticket at the event venue.

15. A web server for facilitating sharing of tickets over a communications network, comprising:
a database for storing a plurality of ticket records, wherein each ticket record includes a unique ticket identifier, a unique identifier for a user and a telephone number for a mobile computing device of a user;
a network interface device communicatively coupled with the communications network; and
a processor configured for:
storing in the database a plurality of ticket records for tickets purchased by a user for entrance by the user to a particular event at an event venue;
generating a plurality of electronic tickets corresponding to the plurality of ticket records, wherein each electronic ticket is configured for entrance by the user to the particular event at the event venue;
transmitting the plurality of electronic tickets to the telephone number of the mobile computing device of the user via the network interface device;
receiving, via the network interface device, a unique identifier for a friend of the user and a telephone number for a mobile computing device of the friend, wherein the unique identifier for the friend and the telephone number are entered by the user into a graphical user interface on the mobile computing device of the user;
accessing in the attached database a particular one of the plurality of ticket records corresponding to a first electronic ticket of the plurality of electronic tickets and replacing the unique identifier for the user and the telephone number for the mobile computing device of the user with the unique identifier for the friend and the telephone number for the mobile computing device of the friend; and
transmitting the first electronic ticket corresponding to the particular one of the plurality of ticket records to the telephone number of the mobile computing device of the friend via the network interface device, wherein the first electronic ticket is configured for entrance by the friend to the particular event at the event venue.

16. The web server of claim 15, wherein the processor is further configured for:
receiving, via the network interface device, a message, including a unique ticket identifier, from the event venue, wherein the unique ticket identifier has been garnered via scanning of the first electronic ticket at the particular event at the event venue;
accessing a ticket record in the attached database using the unique ticket identifier from the first electronic ticket, wherein the ticket record corresponds to the unique ticket identifier; and
storing a data element in the ticket record indicating that the first electronic ticket has been redeemed.

17. The web server of claim 16, wherein each ticket record includes a data element indicating that the electronic ticket has not been redeemed.

18. The web server of claim 17, wherein each of the plurality of electronic tickets further includes a unique code comprising any one of a unique alphanumeric value, a matrix barcode, a linear barcode or a unique image.

19. The web server of claim 18, wherein the processor is further configured for reading a ticket record that has been accessed, determining whether the electronic ticket has been redeemed and sending a message indicating whether the electronic ticket has been redeemed.
